(19) United States
(12) Patent Application Publication
(10) Pub. No.: US 2025/0054172 A1
(43) Pub. Date: Feb. 13, 2025

(54) MEASURING A PART USING DEPTH DATA

(71) Applicant: The Boeing Company, Arlington, VA (US)

(72) Inventors: Kristine Marie Kasper, Renton, WA (US); William D. Kelsey, Issaquah, WA (US); Brian James Smith, Seattle, WA (US); Ethan Weathersby, Seattle, WA (US); Mitchell Middleton, Seattle, WA (US); Miguel Angel Valbuena, Seattle, WA (US)

(21) Appl. No.: 18/448,053

(22) Filed: Aug. 10, 2023

(51) Int. Cl. G06T 7/60; G06T 3/20; G06T 3/60; G06T 7/30; G06T 7/50

(52) U.S. Cl. CPC G06T 7/60; G06T 3/20; G06T 3/60; G06T 7/30; G06T 7/50

(57) ABSTRACT

A method of obtaining a measurement of a part using depth data from a plurality of sensors comprises obtaining first depth data of a monument and a part from a first sensor and second depth data of the monument and the part from a second sensor. A plurality of planes is detected in the first depth data and the second depth data. Each plane of the plurality of planes corresponds to a corresponding face on the monument. The method comprises performing a rotational alignment of the plurality of planes. The method further comprises performing a translational alignment of the rotationally aligned plurality of planes. One or more transformations are determined that align the first depth data and the second depth data to a common coordinate system based upon the rotational alignment and the translational alignment. A measurement of the part is determined based upon aligned depth data.

### BACKGROUND

Part inspection helps to ensure the quality, reliability, and safety of parts. In many instances, trained individuals visually examine and assess the quality, integrity, and compliance of various parts with specific parameters, and identify any defects, deviations, or abnormalities. An inspection process can involve identification of measurement points on the part, for example by referencing engineering drawings to determine measurement start and end points. The measurement itself can be performed using a variety of tools, such as a tape measure, calipers, and thickness gauges. The inspection process can also include human visual inspection of cutter lines, smearing & chip welding, mismatches, gouges, elongated holes, missing or mis-located components, and identification of other defects.

### SUMMARY

Examples are disclosed that relate to obtaining a measurement of a part using depth data from a plurality of sensors. One example provides a method of obtaining a measurement of a part using depth data from a plurality of sensors. The method comprises obtaining first depth data of a monument and a part from a first sensor and second depth data of the monument and the part from a second sensor. A plurality of planes is detected in the first depth data and the second depth data. Each plane of the plurality of planes corresponds to a corresponding face on the monument. The method comprises performing a rotational alignment of the plurality of planes. The method further comprises performing a translational alignment of the rotationally aligned plurality of planes. One or more transformations are determined that align the first depth data and the second depth data to a common coordinate system based upon the rotational alignment and the translational alignment. The method further comprises using the one or more transformations to align the first depth data and the second depth data and thereby form aligned depth data. A measurement of the part is determined based upon the aligned depth data. The method further comprises outputting the measurement of the part.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a system for obtaining a measurement of a part using depth data from a plurality of sensors.

FIG. 2 shows a block diagram of an example system configured to obtain a measurement of a part using depth data from a plurality of sensors.

FIG. 3 illustrates an example of point cloud data including a connected point cloud and a plurality of outliers.

FIG. 4 shows a plurality of planes extracted from the connected point cloud of FIG. 3.

FIG. 5 shows an example of a rotational alignment of a plane.

FIG. 6 shows a flow diagram of an example method for performing a rotational alignment.

FIG. 7 shows an example of a translational alignment of the plane of FIG. 5.

FIG. 8 shows an example plot of aligned depth data for the part of FIG. 1.

FIG. 9 shows another example of a part.

FIGS. 10A-10C illustrate cross-sectional views of the part of FIG. 9.

FIGS. 11A-11C show a flow diagram of an example method for obtaining a measurement of a part using depth data from a plurality of sensors.

FIG. 12 is a block diagram of an example computing system.

### DETAILED DESCRIPTION

As introduced above, in many instances, part inspection involves human visual inspection and manual measurement of parts. For example, measurements of a part can be performed using tools such as a tape measure and calipers to determine dimensions across multiple sections of the part. This process requires the person performing the measurement to be familiar with the inspection plan and engineering drawings, and to maintain precision across different parts which can vary in length from less than one foot to over 100 feet. This is labor intensive, repetitive and can require an extensive amount of time to perform accurately. For example, inspection of a 100-foot-long aircraft stringer can take 1-10 hours.

In some instances, laser measurement devices can be used to determine one or more dimensions of a part. However, reflections can reduce the accuracy of such measurement devices. Furthermore, these measurement devices require a physical calibration of the sensor's mechanical mounting structure, precise part mounting, and controlled temperature conditions to obtain reliable measurements. It can also be challenging to obtain measurements of multiple dimensions and to maneuver a part in multiple degrees of freedom during the measurement process.

Accordingly, examples are disclosed that relate to systems and methods for obtaining a measurement of a part using depth data from a plurality of depth sensors. Briefly, depth data of the part and a monument are obtained from the plurality of depth sensors. A plurality of planes are detected in the depth data. Each plane of the plurality of planes corresponds to a corresponding face on the monument. The plurality of planes are rotationally and translationally aligned. One or more transformations are determined that align the depth data to a common coordinate system based upon the rotational alignment and the translational alignment. The aligned depth data is used to determine and output a measurement of the part.

This process provides for automated, repeatable measurement of parts within a suitable tolerance (e.g., 0.01 inches or less). This process also reduces time required to measure parts and increases inspection throughput. For example, an aircraft stringer inspection can be performed in five minutes or less in some examples.

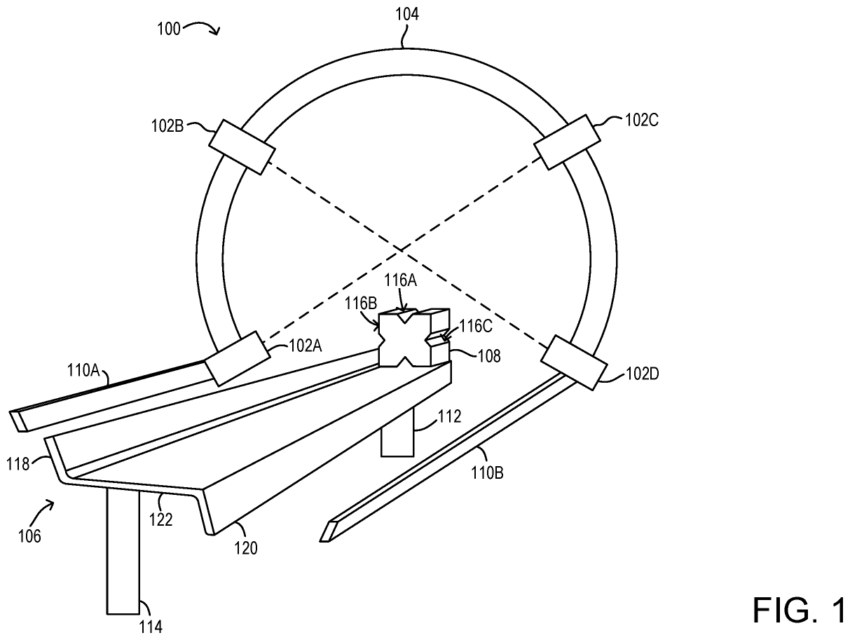

FIG. 1 shows an example of a system 100 for obtaining a measurement of a part. The system 100 comprises a plurality of depth sensors 102A, 102B, 102C, and 102D. In other examples, any other suitable number of depth sensors can be used, such as two, three, five, ten, or more depth sensors.

In some examples, each of the depth sensors 102A, 102B, 102C, and 102D comprises a light detection and ranging (LIDAR) sensor. In other examples, any other suitable depth sensor can be used. Another example of a suitable depth sensor includes a time-of-flight (ToF) depth camera.

In the depicted example, the depth sensors 102A, 102B, 102C, and 102D are mounted in a ring 104 at least partially surrounding a part 106 and a monument 108. In some such examples, the depth sensors 102A, 102B, 102C, and 102D are located at fixed positions relative to one another. The orientations of the depth sensors 102A, 102B, 102C, and 102D are selected such that the depth sensors 102A, 102B, 102C, and 102D can image both the part 106 and the monument 108. The positions and orientations of the depth sensors enables depth data obtained from each of the depth sensors to be aligned to a common coordinate system. In other examples, the sensors can be arranged in any other suitable pattern.

In some examples, the depth sensors 102A, 102B, 102C, and 102D are moveable with respect to the part 106. For example, the ring 104 is mounted on rails 110A and 110B. The rails 110A and 110B enable the ring 104 to be positioned at a predetermined cross-section of the part 106. In this manner, the depth sensors 102A, 102B, 102C, and 102D can obtain depth images along a length of the part 106. In other examples, the depth sensors can be stationary with respect to the part.

In some examples, the part 106 comprises an aircraft stringer. In other examples, the system 100 can be used to measure any other suitable object. Other examples of suitable objects include tubes, ducts, metal parts (e.g., aluminum, titanium, or steel parts), and composite parts (e.g., carbon fiber parts). The system 100 can also have applications beyond the aerospace industry, including automotive, rail, maritime, energy, and engineering applications, or any other applications where inspection of tolerances is required during manufacture or service and inspection.

In some examples, the system 100 includes a pogo mounting and clamping system. The pogo mounting and clamping system comprises a first mount 112 and a second mount 114. The first mount 112 is configured to clamp and hold a portion of the part 106 during a scan in one direction. The second mount 114 is configured to clamp the part 106 at a different location during a scan in an opposite direction. Sensor sequencing is calibrated accordingly. For example, the depth sensors 102A, 102B, 102C, and 102D, the first mount 112, and the second mount 114 can be sequenced based on a CAD file or a digital inspection plan. This enables automation of the part scanning process.

The monument 108 comprises a real-world object with at least three non-parallel faces 116A, 116B, and 116C. The faces 116A, 116B, and 116C serve as a reference by which depth data output from the depth sensors 102A, 102B, 102C, and 102D can be aligned. In the example illustrated in FIG. 1, the monument 108 comprises an X-shaped block. In other examples, the monument 108 can have any other suitable geometry. Other examples of suitable monuments include triangular, pyramidal, and trapezoidal monuments.

Dimensions of each of the faces 116A, 116B, and 116C are machined within a suitable tolerance. In some examples, the faces 116A, 116B, and 116C have dimensions within a tolerance of 0.005-inch or less. In some more specific examples, the faces 116A, 116B, and 116C have dimensions within a tolerance of 0.0005-inch or less. In further more specific examples, the faces 116A, 116B, and 116C have dimensions within a tolerance of 0.0003-inch or less. This allows assembly of an accurate, aligned set of depth data to produce a 3D digital twin of the part 106.

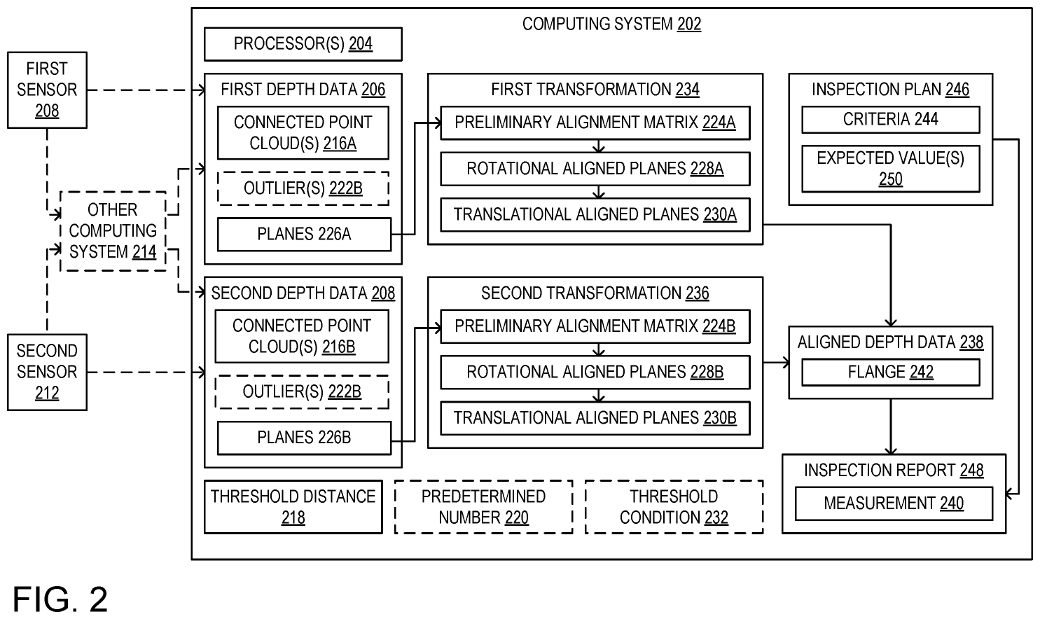

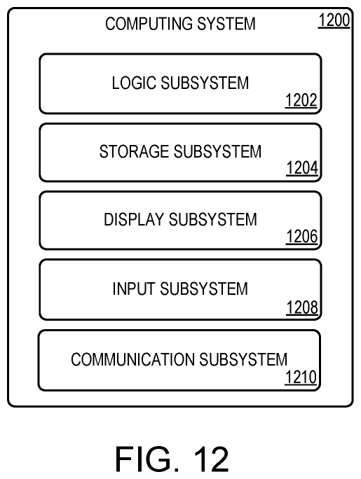

FIG. 2 shows an example of a computing system 202 configured to obtain a measurement of a part using depth data from a plurality of sensors, such as the depth sensors 102A, 102B, 102C, and 102D of FIG. 1. In some examples, the computing system 202 comprises one or more server computing devices. In other examples, the computing system 202 comprises any other suitable computing system. Other examples of suitable computing systems include desktop computing devices and laptop computing devices. Additional aspects of the computing system 202 are described in more detail below with reference to FIG. 12.

The computing system 202 comprises one or more processors 204. The one or more processors 204 are configured to obtain depth data of the monument and the part from the plurality of depth sensors. The computing system 202 is configured to obtain at least first depth data 206 from a first sensor 208 and second depth data 210 from a second sensor 212. In some examples, the first depth data 206 and the second depth data 210 are received from the first sensor 208 and the second sensor 212 in real time. In other examples, the first depth data 206 and the second depth data 210 are received from another computing system 214, such as a cloud storage server.

In some examples, the computing system 202 is configured to identify one or more connected point clouds 216A, 216B in the first depth data 206 and the second depth data 210, respectively. A connected point cloud comprises a plurality of three-dimensional coordinates. Each coordinate of the plurality of three-dimensional coordinates is located within a threshold distance 218 of another coordinate within the connected point cloud.

In some examples, the threshold distance 218 is a predefined distance. In some such examples, the threshold distance 218 is within a range of 0-1 inch. In some more specific examples, the threshold distance 218 is within a range of 0.01-0.5 inch. In further more specific examples, the threshold distance 218 is within a range of 0.1-0.2 inch.

In other examples, the threshold distance 218 is a function of a predetermined number 220 of coordinates in each connected point cloud 216A, 216B. In some such examples, the threshold distance 218 is selected such that each connected point cloud 216A, 216B contains the predetermined number 220 of coordinates. In some examples, the predetermined number 220 of coordinates is in a range of 5,000-500,000. In some more specific examples, the predetermined number 220 of coordinates is in a range of 10,000-100,000. In further more specific examples, the predetermined number 220 of coordinates is in a range of 10,000-15,000. The threshold distance 218 can be selected in any suitable manner. Some examples of suitable methods to define the connected point clouds 216A, 216B include k-means clustering and Gaussian multi-modal analysis. In this manner, discrete surfaces can be identified within the connected point clouds 216A, 216B.

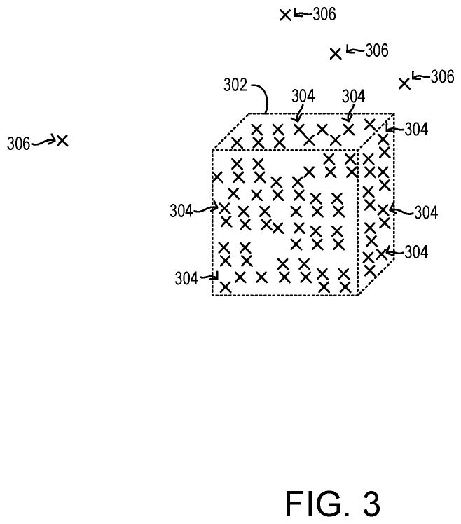

The computing system 202 is optionally configured to remove outliers 222A, 222B from the first depth data 206 and/or the second depth data 210, respectively. The outliers 222A, 222B comprise coordinates within the first depth data 206 and the second depth data 210, if any, that are outside the threshold distance 218 from another coordinate. FIG. 3 shows a schematic example of a connected point cloud 302 comprising a plurality of coordinates 304. FIG. 3 also illustrates outliers 306 that are outside of the connected point cloud 302. Removal of the outliers 306 reduces a size of the depth data in a memory of a computing device and thereby also reduces processing time for subsequent transformation and/or analysis of the depth data. The removal of the outliers 306 also enables precise segmentation of a part or assembly in a desired measurement location.

With reference again to FIG. 2, the computing system 202 is further configured to rotate one or more of the first depth data 206 and the second depth data 210 by an installation angle of a respective sensor 208, 212. In some examples, this is accomplished by applying a first static preliminary alignment matrix 224A to the first depth data 206. The first static preliminary alignment matrix 224A is configured to rotate the first depth data 206 by an installation angle of a first depth sensor. A second static preliminary alignment matrix 224B is applied to the second depth data 210. The second static preliminary alignment matrix 224B is configured to rotate the second depth data 210 by an installation angle of a second depth sensor. For example, depth data obtained from the first depth sensor 102A of FIG. 1 can be rotated by 125 degrees around a central axis of the ring 104. Depth data obtained from the second depth sensor 102B can be rotated by 55 degrees in a same direction around the central axis of the ring 104. Rotating the depth data from each depth sensor by an installation angle of a respective sensor can approximate rotational alignment of the depth sensors suitably close to ensure accurate plane detection and alignment, as described in more detail below.

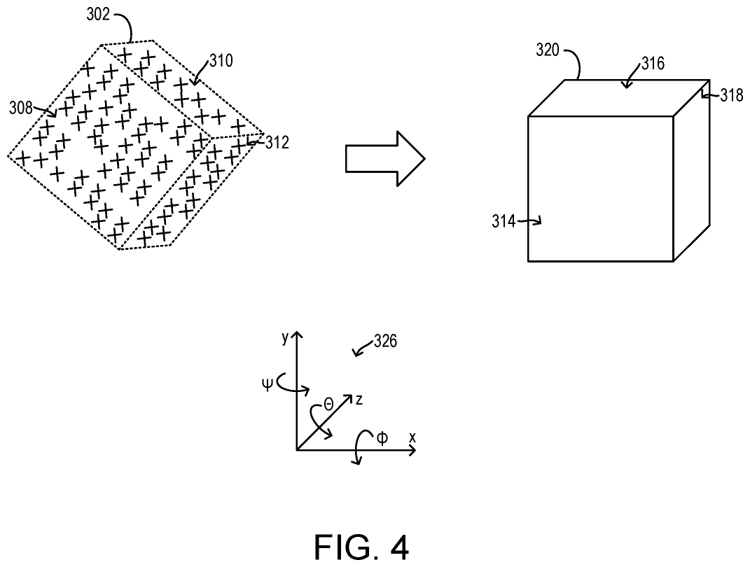

The computing system 202 is further configured to detect a plurality of planes 226A, 226B in the first depth data 206 and the second depth data 210, respectively. Each plane of the plurality of planes 226A, 226B corresponds to a corresponding face on a monument (e.g., the monument 108 of FIG. 1). For example, FIG. 4 shows a plurality of planes 308, 310, 312 in the connected point cloud 302 of FIG. 3. Each plane 308, 310, 312 corresponds to a corresponding face 314, 316, 318, respectively, on a monument 320. The planes can be detected in any suitable manner. One example of a suitable method for detecting the planes 226A, 226B of FIG. 2 is a least-squares best-fit method. Recognizing the planes that correspond to the monument enables the computing system to align the first depth data and the second depth data to a common coordinate system.

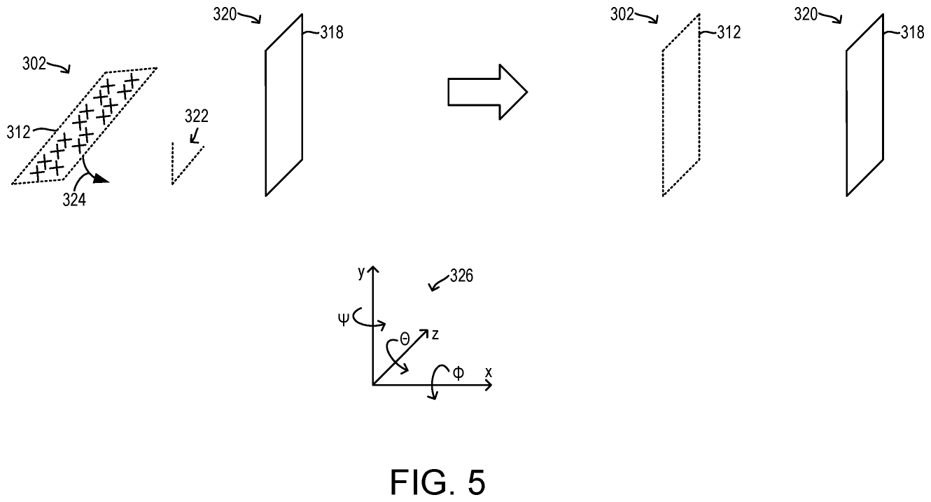

Each plane of the plurality of planes 226A, 226B is rotationally aligned to a corresponding face on the monument as indicated at 228A and 228B, respectively. For example, FIG. 5 shows the plane 312 of FIG. 4. The plane 312 is rotated to align parallel to a known orientation of its corresponding face 318 on the monument 320.

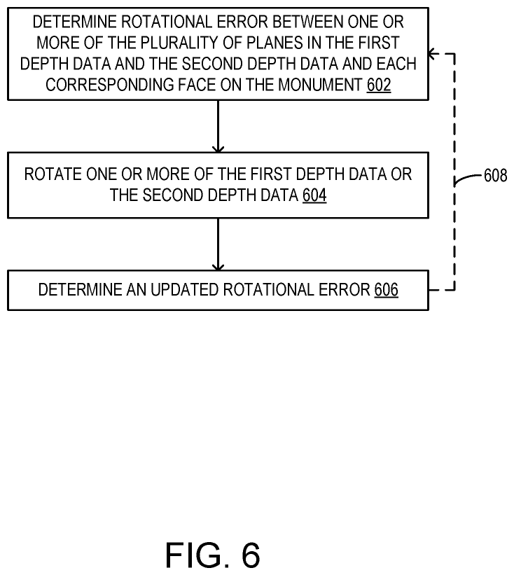

In some examples, the rotational alignment is performed in one or more iterative steps. FIG. 6 illustrates an example method 600 for performing rotational alignment of depth data. At 602, the method 600 comprises determining rotational error between one or more of the plurality of planes in the first depth data and the second depth data and each corresponding face on the monument. FIG. 5 shows an example of rotational error 322 between the plane 312 and the corresponding face 318 on the monument 320.

At 604, the method 600 of FIG. 6 comprises rotating the one or more of the plurality of planes. For example, the plane 312 is rotated, as indicated at 324, to align its orientation to the face 318. In some examples, the rotation 324 comprises an incremental change in phi, psi, and/or theta in coordinate system 326.

Referring again to FIG. 6, the method 600 comprises determining an updated rotational error 322. The method 600 optionally comprises repeating one or more of steps 602-606, as indicated at 608. Steps 602-606 can be repeated any suitable number of times. In some examples, steps 602-606 are repeated until the updated rotational error is within a predetermined rotational error threshold. In some examples, the predetermined rotational error threshold is in a range of 0-1 degree. In some more specific examples, the predetermined rotational error threshold is in a range of 0-0.1 degree. In further more specific examples, the predetermined rotational error threshold is in a range of 0-0.01 degree. In this manner, the depth data is rotated until the rotational error is suitably low to obtain an accurate measurement of the part.

In other examples, steps 602-606 are repeated until a predetermined number of iterations is reached. In some examples, the predetermined number of iterations is within a range of 1-1000 iterations. In some more specific examples, the predetermined number of iterations is within a range of 1-100 iterations. In further more specific examples, the predetermined number of iterations is within a range of 10-100 iterations. In this manner, the rotational alignment can be terminated if the updated rotational error does not converge to the predetermined rotational error threshold within the predetermined number of iterations, thereby preventing the computing device performing the rotational alignment from entering a freeze or hang condition.

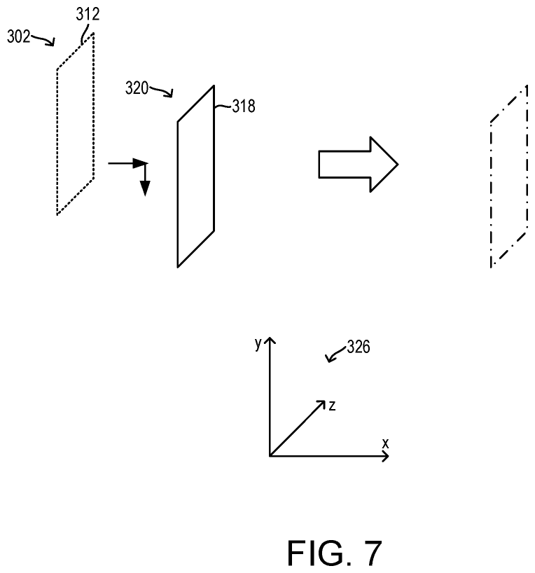

Referring again to FIG. 2, the computing system 202 is configured to perform a translational alignment of the rotationally aligned plurality of planes 228A, 228B, as indicated at 230A and 230B, respectively. FIG. 7 shows the plane 312 after the rotational alignment 324 of FIG. 5. In this manner, the plane 312 is substantially parallel with the corresponding face 318 on the monument 320. As illustrated by example in FIG. 7, the plane 312 is moved to align its position with a known position of the corresponding face 318 on the monument 320. Accordingly, after both the rotational and translational alignments, the plane 312 is aligned to the monument 320 in six degrees of freedom (e.g., in position with respect to the x, y, and z axes, as illustrated by example in FIG. 7, and in orientation with respect to phi, psi, and theta, as illustrated by example in FIG. 5).

In some examples, performing the translational alignment comprises translating one or more of the plurality of planes 226A, 226B in the first depth data 206 and the second depth data 210 until a distance between the one or more of the plurality of planes 226A, 226B and each corresponding face on the monument satisfies a threshold condition 232. In some examples, the threshold condition 232 comprises a shortest distance between each plane 226A, 226B (e.g., a length of a normal vector) and its corresponding face. In this manner, the plurality of planes are aligned to the monument.

The computing system 202 is further configured to determine one or more transformations that align the depth data to a common coordinate system based upon the rotational alignment and the translational alignment. As illustrated by example in FIG. 2, a first transformation 234 is determined for the first depth data 206 and a second transformation 236 is determined for the second depth data 210. The first transformation 234 and the second transformation 236 calibrate the first depth data 206 and the second depth data 210 to the common coordinate system based upon the rotational and translational transformations applied to the plurality of planes 226A, 226B, respectively.

The transformations 234 and 236 are used to align the first depth data 206 and the second depth data 210 and thereby form aligned depth data 238. While the aligned depth data 238 is schematically illustrated as a single structure in FIG. 2, it will also be appreciated by one of ordinary skill in the art, without undue experimentation, that the aligned depth data 238 can alternatively comprise separate data structures (e.g., separate data structures for aligned depth data derived from the first depth data 206 and aligned depth data derived from the second depth data 210).

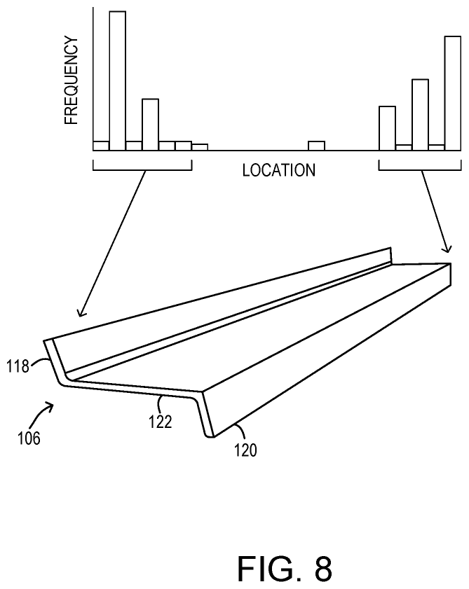

The computing system 202 is further configured to determine a measurement 240 of the part based upon the aligned depth data 238. In some examples, determining the measurement 240 of the part comprises identifying a flange 242 on the part, and determining the measurement 240 at a location of the flange 242. For example, the part 106 of FIG. 1 comprises a first flange 118 and a second flange 120 connected by web 122. FIG. 8 shows a histogram of aligned depth data by location on the part 106. For example, there is a larger quantity of depth data points clustered around the first flange 118 and the second flange 120 than at the web 122. In this manner, the first flange 118 and the second flange 120 can be extracted from the aligned depth data. This enables precise sectioning of the part in one or more desired measurement locations.

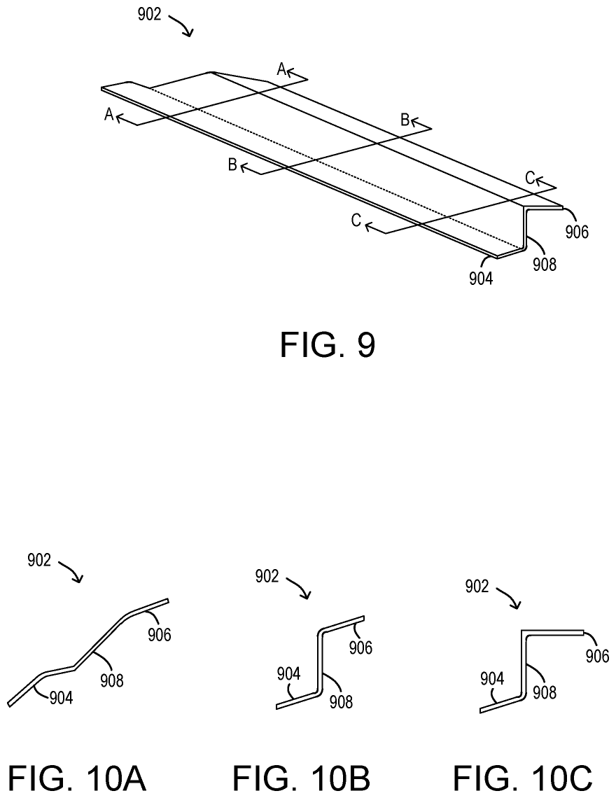

FIG. 9 shows another example of a part 902. As illustrated by example in FIG. 9, in some examples, the part 902 can sag during measurement. Residual stresses can also cause curves in the part. As such, it can be challenging to create a plane that accurately represents an entire surface of a first flange 904, a second flange 906, and/or a web 908. Accordingly, and in one potential advantage of the present disclosure, the aligned depth data for the part 902 can be cross-sectioned at measurement points of interest, as indicated at lines A-A, B-B, and C-C in FIG. 9. FIGS. 10A-10C show cross-sectional views of the part 902 at lines A-A, B-B, and C-C, respectively. The measurement can be determined for each cross-sectional portion of the part 902. Determining the measurement at multiple locations allows the computing system to obtain a more comprehensive representation of its dimensions. For example, an average height of the web 908 can be determined based upon two or more cross-sectional measurements. The average, and/or other statistical measures (e.g., mean and mode) can help eliminate or minimize the impact of individual measurement errors or variations in the dimensions of the part. Other statistical parameters, such as standard deviation or range, can be additionally or alternatively used to quantify the extent of any variability present in the measurement. Taking multiple measurements also enables the computing system to identify errors or biases in the measurement process, and reduces random error relative to the use of fewer measurements.

In some examples, the measurement 240 is determined for multiple locations on each part. Measurement criteria 244, such as measurement locations, can be specified in an inspection plan 246. While the inspection plan 246 is depicted at the computing system 202, it will also be appreciated by one of ordinary skill in the art, without undue experimentation, that the inspection plan 246 can be additionally or alternatively stored at another location, such as the other computing system 214 or a cloud storage database. In some examples, the depth sensors 102A-102B can be relocated to another position along an axis of measurement (e.g., by repositioning the ring 104 along the rails 110A, 110B) to obtain additional depth data of the part 106. In some such examples, depth data for a 100-foot-long part can be obtained and any suitable measurements extracted therefrom within five minutes. This enables accurate inspection of the part without risk of human error, and in a shorter amount of time than manual methods and/or the use of other measurement devices.

Referring again to FIG. 2, in some examples, the measurement 240 is determined within a tolerance of 0-0.01 inch. In some more specific examples, the measurement 240 is determined within a tolerance of 0-0.005 inch. In further more specific examples, the measurement 240 is determined within a tolerance of 0-0.001 inch. In this manner, the computing system 202 can output one or more measurements 240 that are at least comparable to an accuracy tolerance of manual inspection and/or other inspection tools, such as automated calipers or laser measurement devices.

In some examples, the measurement 240 is packaged in an inspection report 248. The inspection report 248 can additionally or alternatively include at least a portion of the inspection plan 246. For example, the inspection report 248 can include the measurement criteria 244, along with one or more expected values 250 for the measurement 240. In this manner, the inspection report 248 can serve as a reference for the inspection of the part.

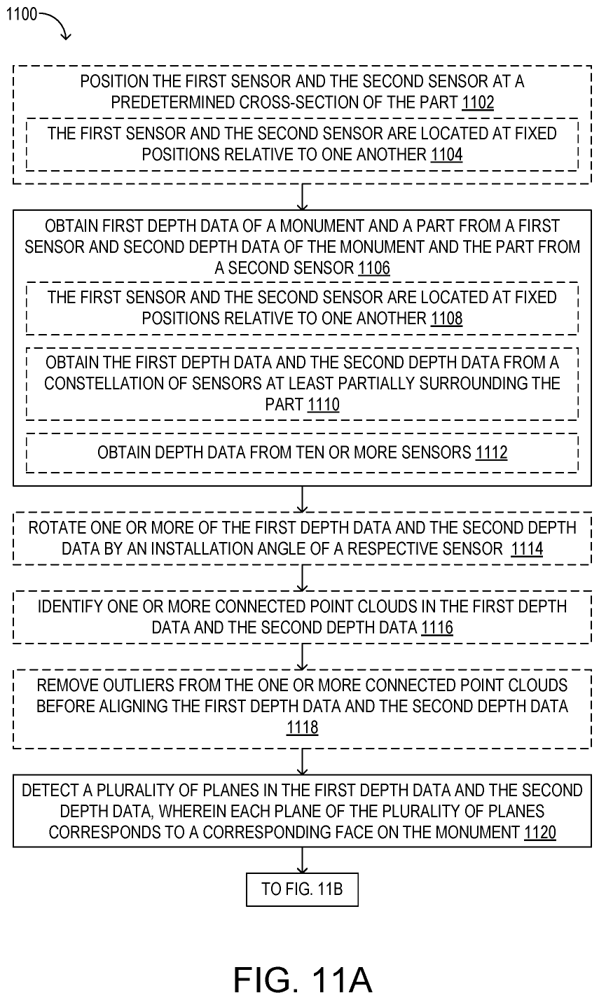

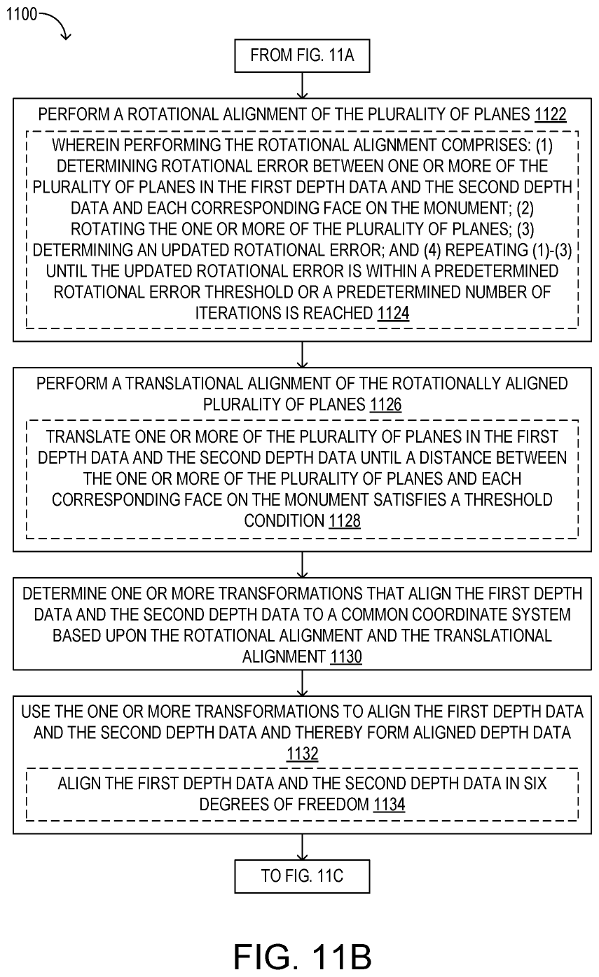

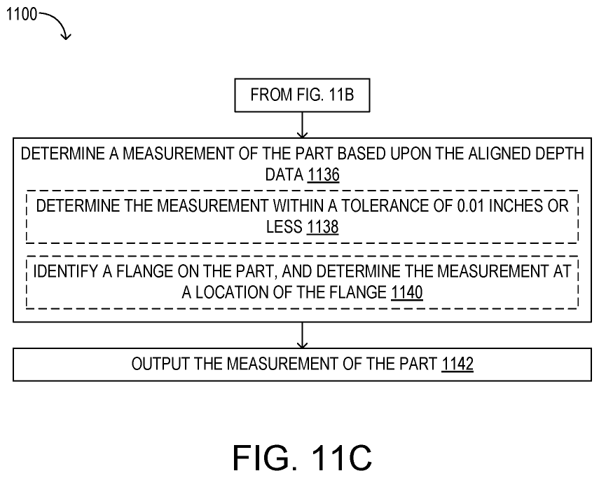

FIGS. 11A-11C show a flow diagram depicting an example method 1100 for obtaining a measurement of a part using depth data from a plurality of sensors. The following description of method 1100 is provided with reference to the components described herein and shown in FIGS. 1-10 and 12. In some examples, the method 1100 is performed at the computing system 202 of FIG. 2. In other examples, the method 1100 can be performed in other contexts using other suitable components.

Referring first to FIG. 11A, at 1102, the method 1100 comprises positioning a first sensor and a second sensor at a predetermined cross-section of a part. For example, the depth sensors 102A, 102B, 102C, and 102D of FIG. 1 are positioned along part 106 by rails 110A and 110B.

In some examples, as indicated at 1104, the first sensor and the second sensor are located at fixed positions relative to one another. For example, the depth sensors 102A, 102B, 102C, and 102D of FIG. 1 are mounted to ring 104 and rails 110A and 110B, which maintain the depth sensors 102A, 102B, 102C, and 102D at fixed positions with respect to one another. This enables depth data output by each of the depth sensors to be calibrated and aligned.

At 1106, the method 1100 includes obtaining first depth data of a monument and a part from a first sensor and second depth data of the monument and the part from a second sensor. For example, the computing system 202 of FIG. 2 is configured to obtain at least first depth data 206 from first sensor 208 and second depth data 210 from second sensor 212. The depth sensors 102A, 102B, 102C, and 102D of FIG. 1 are examples of depth sensors suitable for use as the first sensor 208 and the second sensor 212.

In some examples, as indicated at 1108, the monument comprises at least three non-parallel faces. For example, the monument 108 of FIG. 1 comprises at least three non-parallel faces 116A, 116B, and 116C. These faces serve as references for alignment of the depth data.

At 1110, in some examples, the method 1100 includes obtaining the first depth data and the second depth data from a constellation of sensors at least partially surrounding the part. For example, the depth sensors 102A, 102B, 102C, and 102D of FIG. 1 are arranged in a ring 104 at least partially surrounding part 106 and monument 108. In this manner, the depth sensors obtain depth data from different perspectives, which can be merged in a common coordinate system.

In some examples, at 1112, obtaining the first depth data and the second depth data comprises obtaining depth data from ten or more sensors. As described above, any other suitable number of depth sensors can be used, such as two, three, four, five, etc.

At 1114, in some examples, the method 1100 includes rotating one or more of the first depth data and the second depth data by an installation angle of a respective sensor before aligning the first depth data and the second depth data. For example, the computing system 202 of FIG. 2 is configured to use a first static preliminary alignment matrix 224A to rotate the first depth data 206 by an installation angle of the first depth sensor 208. A second static preliminary alignment matrix 224B is used to rotate the second depth data 210 by an installation angle of a second depth sensor 212. This rotation approximates rotational alignment of the depth sensors suitably close to enable accurate plane detection and alignment.

In some examples, at 1116, the method 1100 comprises identifying one or more connected point clouds in the first depth data and the second depth data. For example, FIG. 3 shows a connected point cloud 302 comprising a plurality of coordinates 304. At 1118, the method 1100 comprises removing outliers from the one or more connected point clouds before aligning the first depth data and the second depth data. For example, FIG. 3 also shows outliers 306 from the connected point cloud 302. This cleans the connected point cloud for further processing.

At 1120, the method 1100 comprises detecting a plurality of planes in the first depth data and the second depth data, wherein each plane of the plurality of planes corresponds to a corresponding face on the monument. For example, FIG. 4 shows a plurality of planes 308, 310, 312 that each correspond to a corresponding face 314, 316, 318, respectively, on a monument 320. Recognizing planes in the depth data that correspond to specific faces on the monument enables the computing system to align the depth data to a common coordinate system.

Referring now to FIG. 11B, at 1122, the method 1100 comprises performing a rotational alignment of the plurality of planes. For example, FIG. 5 shows rotational alignment of plane 312 to its corresponding face 318 on the monument 320.

In some examples, at 1124, performing the rotational alignment comprises: (1) determining rotational error between one or more of the plurality of planes in the first depth data and the second depth data and each corresponding face on the monument; (2) rotating the one or more of the plurality of planes; (3) determining an updated rotational error; and (4) repeating (1)-(3) until the updated rotational error is within a predetermined rotational error threshold or a predetermined number of iterations is reached. In this manner, the depth data is rotated until the detected planes are substantially parallel to their corresponding faces on the monument.

At 1126, the method 1100 comprises performing a translational alignment of the rotationally aligned plurality of planes. For example, FIG. 7 shows a translational alignment of the plane 312 with the corresponding face 318 on the monument 320. In this manner, the plane 312 is substantially superimposed on the corresponding face 318.

In some examples, at 1128, performing the translational alignment comprises translating one or more of the plurality of planes in the first depth data and the second depth data until a distance between the one or more of the plurality of planes and each corresponding face on the monument satisfies a threshold condition. For example, as described above, the threshold condition can include a shortest distance between each plane (e.g., a length of a normal vector) and its corresponding face. In this manner, the plane can be moved until it is located as close as possible to the monument.

At 1130, the method 1100 comprises determining one or more transformations that align the first depth data and the second depth data to a common coordinate system based upon the rotational alignment and the translational alignment. The method 1100 further comprises, at 1132, using the one or more transformations to align the first depth data and the second depth data and thereby form aligned depth data. For example, the computing system 202 is configured to determine first transformation 234 and second transformation 236 for the first depth data 206 and the second depth data 210, respectively. In this manner, the first depth data and the second depth data can be calibrated to a common coordinate system based upon the rotational and translational transformations applied to the plurality of planes.

In some examples, at 1134, using the one or more transformations to align the first depth data and the second depth data comprises aligning the first depth data and the second depth data in six degrees of freedom. For example, as described above, the rotational alignment can comprise a change in phi, psi, and/or theta in coordinate system 326 of FIG. 3. The translational alignment can comprise a change in the x-, y-, and/or z-axis position in the coordinate system 326. In this manner, the position and the orientation of the first depth data and the second depth data can be aligned.

At 1136, the method 1100 comprises determining a measurement of the part based upon the aligned depth data. In some examples, at 1138, determining the measurement comprises determining the measurement within a tolerance of 0.01 inches or less. The measurement threshold can be a function of a manufacturing tolerance of the monument, the tolerance of the rotational alignment, and the tolerance of the translational alignment. Maintaining suitably low tolerances enables precise measurement of the part.

At 1140, in some examples, determining the measurement of the part comprises identifying a flange on the part, and determining the measurement at a location of the flange. For example, the part 106 of FIG. 1 comprises a first flange 118 and a second flange 120. A height of the part 106 can be measured by comparing a distance between the first flange 118 and the second flange 120.

The method 1100 further comprises, at 1142, outputting the measurement of the part. For example, the computing system 202 of FIG. 2 is configured to determine and output measurement 240. As described above, the computing system 202 can package the measurement 240 in an inspection report 248, which can serve as a reference for the inspection of the part.

In some embodiments, the examples described herein can be tied to a computing system of one or more computing devices. In particular, aspects of such methods and processes can be implemented as a computer-application program or service, an API, a library, and/or other computer-program product.

FIG. 12 schematically shows a non-limiting embodiment of a computing system 1200 that can enact one or more of the examples described above. For example, computing system 1200 can be used to execute instructions to perform the method 1100 of FIGS. 11A-11C and/or potentially perform other functions.

Computing system 1200 is shown in simplified form. Computing system 1200 can take the form of one or more personal computers, server computers, tablet computers, network computing devices, mobile computing devices, mobile communication devices (e.g., smart phones), and/or other computing devices. In some examples, the computing system 202 of FIG. 2 comprises one or more aspects of the computing system 1200.

Computing system 1200 includes a logic subsystem 1202, a storage subsystem 1204, and an optional display subsystem 1206. Computing system 1200 can optionally include an input subsystem 1208, a communication subsystem 1210, and/or other computing-related components not shown in FIG. 12.

Logic subsystem 1202 includes one or more physical devices configured to execute instructions. For example, logic subsystem 1202 can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result. For example, logic subsystem 1202 can be used to execute instructions to perform the method 1100 of FIGS. 11A-11C.

Logic subsystem 1202 can include one or more processors configured to execute software instructions. Additionally or alternatively, logic subsystem 1202 can include one or more hardware or firmware logic machines configured to execute hardware or firmware instructions. Processors of logic subsystem 1202 can be single-core or multi-core, and the instructions executed thereon can be configured for sequential, parallel, and/or distributed processing. Individual components of logic subsystem 1202 optionally can be distributed among two or more separate devices, which can be remotely located and/or configured for coordinated processing. Aspects of logic subsystem 1202 can be virtualized and executed by remotely accessible, networked computing devices configured in a cloud-computing configuration.

Storage subsystem 1204 includes one or more physical devices configured to hold instructions executable by logic subsystem 1202 to implement the methods and processes described herein. For example, storage subsystem 1204 can hold instructions executable to perform the method 1100 of FIGS. 11A-11C and/or potentially perform other functions. When such methods and processes are implemented, the state of storage subsystem 1204 can be transformed—e.g., to hold different data.

Storage subsystem 1204 can include removable and/or built-in devices. Storage subsystem 1204 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1204 can include volatile, nonvolatile, dynamic, static, read/write, read-only, random-access, sequential-access, location-addressable, file-addressable, and/or content-addressable devices.

It will be appreciated by those of ordinary skill in the art, without undue experimentation, that storage subsystem 1204 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1202 and storage subsystem 1204 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, a display subsystem 1206 can be used to present a visual representation of data held by storage subsystem 1204. This visual representation can take the form of a graphic user interface (GUI). As the herein described methods and processes change the data held by the storage subsystem 1204, and thus transform the state of the storage machine, the state of display subsystem 1206 can likewise be transformed to visually represent changes in the underlying data.

When included, a display subsystem 1206 can include one or more display devices utilizing virtually any type of technology. Such display devices can be combined with logic subsystem 1202 and/or storage subsystem 1204 in a shared enclosure, or such display devices can be peripheral display devices.

When included, input subsystem 1208 can comprise or interface with one or more user-input devices such as a keyboard, mouse, touch screen, or joystick. In some embodiments, the input subsystem 1208 can comprise or interface with selected natural user input (NUI) componentry. Such componentry can be integrated or peripheral, and the transduction and/or processing of input actions can be handled on- or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, and without respect to the dynamic and reconfigurable communication system described above, the communication subsystem 1210 can be configured to communicatively couple computing system 1200 with one or more other computing devices. Communication subsystem 1210 can include wired and/or wireless communication devices compatible with one or more different communication protocols. As non-limiting examples, the communication subsystem can be configured for communication via a wireless telephone network, or a wired or wireless local- or wide-area network. In some embodiments, communication subsystem 1210 can allow computing system 1200 to send and/or receive messages (e.g., the first depth data 206, the second depth data 208, or the measurement 240) to and/or from other devices via a network such as the Internet. For example, communication subsystem 1210 can be used to receive or send data to another computing system. As another example, communication subsystem may be used to communicate with other computing systems, such as during execution of method 1100 in a distributed computing environment.

Further, the disclosure comprises configurations according to the following clauses.

Clause 1. At a computing system, a method of obtaining a measurement of a part using depth data from a plurality of sensors, the method comprising: obtaining first depth data of a monument and a part from a first sensor and second depth data of the monument and the part from a second sensor; detecting a plurality of planes in the first depth data and the second depth data, wherein each plane of the plurality of planes corresponds to a corresponding face on the monument; performing a rotational alignment of the plurality of planes; performing a translational alignment of the rotationally aligned plurality of planes; determining one or more transformations that align the first depth data and the second depth data to a common coordinate system based upon the rotational alignment and the translational alignment; using the one or more transformations to align the first depth data and the second depth data and thereby form aligned depth data; determining a measurement of the part based upon the aligned depth data; and outputting the measurement of the part.

Clause 2. The method of clause 1, wherein determining the measurement comprises determining the measurement within a tolerance of 0.01 inches or less.

Clause 3. The method of clause 1, wherein using the one or more transformations to align the first depth data and the second depth data comprises aligning the first depth data and the second depth data in six degrees of freedom.

Clause 4. The method of clause 1, further comprising obtaining the first depth data and the second depth data from a constellation of sensors at least partially surrounding the part.

Clause 5. The method of clause 1, further comprising, before obtaining the first depth data and the second depth data, positioning the first sensor and the second sensor at a predetermined cross-section of the part.

Clause 6. The method of clause 1 wherein obtaining the first depth data and the second depth data comprises obtaining depth data from ten or more sensors.

Clause 7. The method of clause 1, further comprising: identifying one or more connected point clouds in the first depth data and the second depth data; and removing outliers from the one or more connected point clouds before aligning the first depth data and the second depth data.

Clause 8. The method of clause 1, further comprising rotating one or more of the first depth data and the second depth data by an installation angle of a respective sensor before aligning the first depth data and the second depth data.

Clause 9. The method of clause 1, wherein performing the rotational alignment comprises: (1) determining rotational error between one or more of the plurality of planes in the first depth data and the second depth data and each corresponding face on the monument; (2) rotating the one or more of the plurality of planes; (3) determining an updated rotational error; and (4) repeating (1)-(3) until the updated rotational error is within a predetermined rotational error threshold or a predetermined number of iterations is reached.

Clause 10. The method of clause 1, wherein performing the translational alignment comprises translating one or more of the plurality of planes in the first depth data and the second depth data until a distance between the one or more of the plurality of planes and each corresponding face on the monument satisfies a threshold condition. Clause 11. The method of clause 1, wherein determining the measurement of the part comprises identifying a flange on the part, and determining the measurement at a location of the flange.

Clause 12. The method of clause 1, wherein the first sensor and the second sensor are located at fixed positions relative to one another.

Clause 13. The method of clause 1, wherein the monument comprises at least three non-parallel faces.

Clause 14. A computing system, comprising one or more processors configured to: obtain first depth data of a monument and a part from a first sensor and second depth data of the monument and the part from a second sensor; detect a plurality of planes in the first depth data and the second depth data, wherein each plane of the plurality of planes corresponds to a corresponding face on the monument; perform a rotational alignment of the first depth data and the second depth data based upon the plurality of planes; perform a translational alignment of the rotationally aligned first depth data and the rotationally aligned second depth data based upon the plurality of planes; determine one or more transformations that align the first depth data and the second depth data to a common coordinate system based upon the rotational alignment and the translational alignment; use the one or more transformations to align the first depth data and the second depth data, and thereby form aligned depth data; determine a measurement of the part based upon the aligned depth data; and output the measurement of the part.

Clause 15. The computing system of clause 14, wherein the measurement is determined within a tolerance of 0.01 inches or less.

Clause 16. The computing system of clause 14, wherein the one or more processors are further configured to: identify one or more connected point clouds in the first depth data and the second depth data; and remove outliers from the one or more connected point clouds before aligning the first depth data and the second depth data.

Clause 17. The computing system of clause 14, wherein the one or more processors are further configured to: rotate one or more of the first depth data and the second depth data by an installation angle of a respective sensor before aligning the first depth data and the second depth data.

Clause 18. The computing system of clause 14, wherein the one or more processors are further configured to: (1) determine rotational error between one or more of the plurality of planes in the first depth data and the second depth data and each corresponding face on the monument; (2) rotate one or more of the first depth data or the second depth data; (3) determine an updated rotational error; and (4) repeat (1)-(3) until the updated rotational error is within a predetermined rotational error threshold or a predetermined number of iterations is reached.

Clause 19. The computing system of clause 14, wherein the one or more processors are further configured to translate the first depth data until a distance between the plurality of planes in the first depth data and the corresponding faces on the monument satisfies a threshold condition.

Clause 20. A system, comprising: a plurality of depth sensors arranged in a constellation at least partially surrounding a part and a monument; one or more processors; and a memory storing instructions executable by the one or more processors to, obtain depth data of the monument and the part from the plurality of depth sensors; detect a plurality of planes in the depth data, wherein each plane of the plurality of planes corresponds to a corresponding face on the monument; perform a rotational alignment of the depth data based upon the plurality of planes; perform a translational alignment of the rotationally aligned depth data based upon the plurality of planes; determine one or more transformations that align the depth data to a common coordinate system based upon the rotational alignment and the translational alignment; use the one or more transformations to align the depth data and thereby form aligned depth data; determine a measurement of the part based upon the aligned depth data; and output the measurement of the part.

This disclosure is presented by way of example and with reference to the associated drawing figures. Components, process steps, and other elements that can be substantially the same in one or more of the figures are identified coordinately and are described with minimal repetition. It will be noted, however, that elements identified coordinately can also differ to some degree. It will be further noted that some figures can be schematic and not drawn to scale. The various drawing scales, aspect ratios, and numbers of components shown in the figures can be purposely distorted to make certain features or relationships easier to see.

“And/or” as used herein is defined as the inclusive or V, as specified by the following truth table:

| A | B | A ∨ B |
|---|---|---|
| True | True | True |
| True | False | True |
| False | True | True |
| False | False | False |

The terminology “one or more of A or B” as used herein comprises A, B, or a combination of A and B. The terminology “one or more of A, B, or C” is equivalent to A, B, and/or C. As such, “one or more of A, B, or C” as used herein comprises A individually, B individually, C individually, a combination of A and B, a combination of A and C, a combination of B and C, or a combination of A, B and C.

It will be understood that the configurations and/or approaches described herein are exemplary in nature, and that these specific embodiments or examples are not to be considered in a limiting sense, because numerous variations are possible. The specific routines or methods described herein can represent one or more of any number of strategies. As such, various acts illustrated and/or described can be performed in the sequence illustrated and/or described, in other sequences, in parallel, or omitted. Likewise, the order of the above-described processes can be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. At a computing system, a method of obtaining a measurement of a part using depth data from a plurality of sensors, the method comprising:
obtaining first depth data of a monument and a part from a first sensor and second depth data of the monument and the part from a second sensor;
detecting a plurality of planes in the first depth data and the second depth data, wherein each plane of the plurality of planes corresponds to a corresponding face on the monument;
performing a rotational alignment of the plurality of planes;
performing a translational alignment of the rotationally aligned plurality of planes;
determining one or more transformations that align the first depth data and the second depth data to a common coordinate system based upon the rotational alignment and the translational alignment;
using the one or more transformations to align the first depth data and the second depth data and thereby form aligned depth data;
determining a measurement of the part based upon the aligned depth data; and
outputting the measurement of the part.

2. The method of claim 1, wherein determining the measurement comprises determining the measurement within a tolerance of 0.01 inches or less.

3. The method of claim 1, wherein using the one or more transformations to align the first depth data and the second depth data comprises aligning the first depth data and the second depth data in six degrees of freedom.

4. The method of claim 1, further comprising obtaining the first depth data and the second depth data from a constellation of sensors at least partially surrounding the part.

5. The method of claim 1, further comprising, before obtaining the first depth data and the second depth data, positioning the first sensor and the second sensor at a predetermined cross-section of the part.

6. The method of claim 1 wherein obtaining the first depth data and the second depth data comprises obtaining depth data from ten or more sensors.

7. The method of claim 1, further comprising:
identifying one or more connected point clouds in the first depth data and the second depth data; and
removing outliers from the one or more connected point clouds before aligning the first depth data and the second depth data.

8. The method of claim 1, further comprising rotating one or more of the first depth data and the second depth data by an installation angle of a respective sensor before aligning the first depth data and the second depth data.

9. The method of claim 1, wherein performing the rotational alignment comprises:
(1) determining rotational error between one or more of the plurality of planes in the first depth data and the second depth data and each corresponding face on the monument;
(2) rotating the one or more of the plurality of planes;
(3) determining an updated rotational error; and
(4) repeating (1)-(3) until the updated rotational error is within a predetermined rotational error threshold or a predetermined number of iterations is reached.

10. The method of claim 1, wherein performing the translational alignment comprises translating one or more of the plurality of planes in the first depth data and the second depth data until a distance between the one or more of the plurality of planes and each corresponding face on the monument satisfies a threshold condition.

11. The method of claim 1, wherein determining the measurement of the part comprises identifying a flange on the part, and determining the measurement at a location of the flange.

12. The method of claim 1, wherein the first sensor and the second sensor are located at fixed positions relative to one another.

13. The method of claim 1, wherein the monument comprises at least three non-parallel faces.

14. A computing system, comprising one or more processors configured to:
obtain first depth data of a monument and a part from a first sensor and second depth data of the monument and the part from a second sensor;
detect a plurality of planes in the first depth data and the second depth data, wherein each plane of the plurality of planes corresponds to a corresponding face on the monument;
perform a rotational alignment of the first depth data and the second depth data based upon the plurality of planes;
perform a translational alignment of the rotationally aligned first depth data and the rotationally aligned second depth data based upon the plurality of planes;
determine one or more transformations that align the first depth data and the second depth data to a common coordinate system based upon the rotational alignment and the translational alignment;
use the one or more transformations to align the first depth data and the second depth data, and thereby form aligned depth data;
determine a measurement of the part based upon the aligned depth data; and
output the measurement of the part.

15. The computing system of claim 14, wherein the measurement is determined within a tolerance of 0.01 inches or less.

16. The computing system of claim 14, wherein the one or more processors are further configured to:
identify one or more connected point clouds in the first depth data and the second depth data; and
remove outliers from the one or more connected point clouds before aligning the first depth data and the second depth data.

17. The computing system of claim 14, wherein the one or more processors are further configured to: rotate one or more of the first depth data and the second depth data by an installation angle of a respective sensor before aligning the first depth data and the second depth data.

18. The computing system of claim 14, wherein the one or more processors are further configured to:
(1) determine rotational error between one or more of the plurality of planes in the first depth data and the second depth data and each corresponding face on the monument;
(2) rotate one or more of the first depth data or the second depth data;
(3) determine an updated rotational error; and
(4) repeat (1)-(3) until the updated rotational error is within a predetermined rotational error threshold or a predetermined number of iterations is reached.

19. The computing system of claim 14, wherein the one or more processors are further configured to translate the first depth data until a distance between the plurality of planes in the first depth data and the corresponding faces on the monument satisfies a threshold condition.

20. A system, comprising:
a plurality of depth sensors arranged in a constellation at least partially surrounding a part and a monument;
one or more processors; and
a memory storing instructions executable by the one or more processors to,
obtain depth data of the monument and the part from the plurality of depth sensors;
detect a plurality of planes in the depth data, wherein each plane of the plurality of planes corresponds to a corresponding face on the monument;
perform a rotational alignment of the depth data based upon the plurality of planes;
perform a translational alignment of the rotationally aligned depth data based upon the plurality of planes;
determine one or more transformations that align the depth data to a common coordinate system based upon the rotational alignment and the translational alignment;
use the one or more transformations to align the depth data and thereby form aligned depth data;
determine a measurement of the part based upon the aligned depth data; and
output the measurement of the part.
